(19) United States
(12) Patent Application Publication
(10) Pub. No.: US 2022/0295836 A1
(43) Pub. Date: Sep. 22, 2022

(54) NOVEL METHOD FOR PROCESSING SPROUTED WHOLE GRAIN MIXTURE

(71) Applicant: SSIAL FOOD INC., Chungcheongbuk-do (KR)

(72) Inventors: Sang Beom LEE, Chungcheongbuk-do (KR); Jinshick KIM, Chungcheongbuk-do (KR); Woon Sang LEE, Chungcheongbuk-do (KR); Je Hong LEE, Seoul (KR); Soon Seong KIM, Seoul (KR); Kichul HA, Seoul (KR); Hee Eun CHOI, Seoul (KR); Young Kyung KIM, Seoul (KR)

(73) Assignee: SSIAL FOOD INC., Chungcheongbuk-do (KR)

(21) Appl. No.: 17/312,899

(22) PCT Filed: Mar. 26, 2021
(86) PCT No.: PCT/KR2021/003757

§ 371 Date: Jun. 10, 2021

(30) Foreign Application Priority Data
Mar. 19, 2021 (KR) 10-2021-0035956

(51) Int. Cl. A23L 7/00; A23L 5/30; A23L 5/10

(52) U.S. Cl. CPC A23L 7/00; A23L 5/30; A23L 5/15

(57) ABSTRACT

The present invention relates to a method for mixing and processing sprouted whole grain mixture. More particularly, the method includes sprouting whole grains such as brown rice, wheat, barley, oat, Sorghum, etc., and mixing and processing the sprouted whole grains at a time. The mixing and processing process of the whole grains include: (i) steaming the sprouted whole grains to gelatinize the same (in α state); (ii) primary drying; (iii) milling; (iv) baking; and (v) secondary drying of the whole grains. The whole grains according to the present invention maintain gelatinization of starch (in α state), thereby providing soft texture. Further, the whole grains are sugar-free and additive-free while minimizing loss of physiological active ingredients such as dietary fiber, GABA, etc., thereby being helpful in preventing adult disease and promoting health.

### TECHNICAL FIELD

The present invention relates to a method for mixing sprouted whole grains at a time and processing the mixture. More particularly, the present invention relates to a method for mixing and processing sprouted whole grains, which includes sprouting whole grains and then processing the sprouted whole grains.

### BACKGROUND ART

Brown rice is rice obtained by removing rice husk after drying and threshing harvested rice. The brown rice has better storage while being less damaged by insects and/or microorganisms than white rice. However, the brown rice is difficult to cook due to a thick rice bran layer and entails high loss of vitamin B at a high temperature, although the brown rice is favored by patients who avoid carbohydrate intake because nutrients contained in the brown rice are not sufficiently digested or absorbed.

Barley is referred to as super food and contains carbohydrates, protein, fat, fiber, ash, vitamin B1, B2, niacin, folic acid, calcium, iron, etc., which help prevention of beriberi or anemia. Further, dietary fiber contained therein may facilitate bowel movement and digestion and this is good for prevention of constipation and diet. Panthothenic acid contained in barley may improve digestive ability, while proanthocyanidin may help prevention of cancer and enhance immunity. Barley may inhibit blood sugar to assist patients suffering from diabetics to easily eat, while decreasing a cholesterol level to achieve effects of preventing vascular diseases.

Wheat contains phenol compounds, carotinoid, non-starch polysaccharides, lignan, steroids, unsaturated fatty acid, vitamin E, vitamin B complex, minerals, etc. in addition to carbohydrates, protein, fat, fiber and ash. Wheat is known to have effects such as evacuation improvement, weight loss, antioxidative and anti-tumor activities, blood improvement, drop in blood sugar level and the like.

Oat has been selected as super food and thus is increasingly consumed. Oat contains carbohydrates, protein, fat, fiber, ash, minerals and vitamin. Further, oat includes essential amino acids such as lysine and minerals such as calcium, and is also rich in water-soluble fibers to reduce cholesterols. In addition, oat is also rich in antioxidant ingredients such as polyphenols, which are helpful in preventing adult diseases. Further, β-glucan contained in oats may inhibit digestion and absorption of sugars, adjust insulin secretion, decrease a blood sugar level in diabetics, other diverse physiological activities such as prevention of colorectal cancer, as well as, is effective in diet because of efficacies of removing feces long contained in the intestines, that is, coprostasis, while discharging intestinal wastes. Moreover, oat is preferably used for preventing adult diseases while facilitating growth of children in a growing period.

Sorghum (Sorghum bicolor L. Moench) is an annual herbaceous plant of the monocotyledonous plants and is a crop of highland or cultivated land which can be harvested in 80 days after seeding. Sorghum contains large amounts of minerals and vitamin in addition to carbohydrates, protein, fat, fiber and ash. Sorghum is rich in water-soluble dietary fiber to decrease a cholesterol value, in which an anthocyanin component reinforces the immunity of urinary bladder while alleviating inflammation of the same. Further, Sorghum is abundant in antioxidant ingredients such as polyphenols, tannin, etc. so as to remove activated oxygen and provide antiaging effects of cells. Further, Sorghum contains minerals in large amounts thus to help regeneration of cells. Sorghum does not contain gluten and thus is preferably used to manufacture gluten-free products, and may facilitate bowel movement to aid digestion. However, due to tannin, a patient suffering from constipation should carefully intake the same.

GABA (γ-aminobutyric acid, gamma-aminobutyric acid) is an amino acid included in the cerebrospinal fluid, which is an inhibitory neurotransmitter significant in the central nervous system and acts to enhance brain metabolism and circulation. Further, this material may facilitate nervous sedation and help prevention of brain diseases and dementia. WHO recommends the intake of GABA by 6 mg per day.

Dietary fiber is cellulose of indigestible polymer materials (in particular, glucose polymer linked by beta bond in a form of chain) and may be classified into water-insoluble dietary fiber which is not soluble in water and water-soluble dietary fiber consisting of components to form a cell wall of the plant (serving as a binder such as pectin or gum to aggregate plant cells while being dissolved or swollen in water). When taking the dietary fiber forming the cell wall of the plant such as fruits, vegetables, etc., intestinal bifido-bacteria are increased to facilitate smooth bowel movement or excavation while improving immunity so as to prevent an occurrence of colorectal cancer. Furthermore, the dietary fiber may help weight loss, inhibition of fat absorption, inhibition of fat synthesis, body fat degradation and suppression of an increase in blood sugar after a meal. WHO recommends the intake of dietary fiber by 27 to 40 g per day based on total dietary fiber (14 g per 1000 kcal of diet). According to USDA Food Data Central Database regarding to comparison of dietary fiber values before and after sprouting whole grains, the dietary fiber is generally increased after sprouting, however, in the case of wheat when sprouted, it was found that a content of dietary fiber is significantly reduced. With regard to the contents of dietary fiber before and after sprouting, this content was increased from 1.4 to 2.0 in brown rice and from 17 to 34 in barley, respectively. On the other hand, wheat showed the content of dietary fiber decreased from 16 to 1.1. Further, the above content was increased from 10.1 to 11.4 in oats while being decreased from 6.7 to 6.0 in Sorghum.

A technique for processing grains is substantially limited in mixing and processing the grains due to inherent physical properties of the grains. For instance, when typical rice and oats are admixed to cook boiled rice or baked, the oats are generally underdone compared to the rice. That is, due to the husk of oats and a thickness thereof, it requires more time till well done.

Although Korean Patent Registration Publication Nos. 10-1231000 and 10-1841738 disclose a method for production of whole grains, it is still difficult to process whole grains with rough texture not easy to intake.

### PRIOR ART DOCUMENT

### Patent Document

(Patent Document 1) (0001) Korean Patent Registration Publication No. 10-1231000

(Patent Document 2) (0002) Korean Patent Registration Publication No. 10-1841738

### SUMMARY OF INVENTION

### Problems to be Solved by Invention

In consideration of the above-mentioned circumstances, an object of the present invention is to provide a method for processing mixed whole grains, whereby dietary fiber and physiologically active ingredients included in the whole grains can be retained while having soft texture.

Further, another object of the present invention is to provide a method for processing whole grains, which includes: sprouting whole grains having different shapes and physical properties and rough texture, respectively; mixing the sprouted whole grains; and processing the same at a time. Specifically, there is provided a processing method of whole grains that minimizes time and man power required for processing and reduces production costs since the whole grains are processed at a time without processing the same separately.

### Means for Solving Problems

In order to achieve the above objects, according to the present invention, there is provided a method for processing mixed whole grains, which includes mixing and processing sprouted whole grains simultaneously so as to maintain gelatinization of starch (in α state), thereby obtaining soft texture.

The method for processing mixed whole grains according to the present invention may include:

(a) sprouting whole grains; and

(b) processing the sprouted whole grains,

wherein the whole grains in step (a) may be any one or more selected from brown rice, wheat, barley, oat, Sorghum, black rice, red rice, green rice, buckwheat, corn, kamut, quinoa and chick peas. Further, according to one embodiment of the present invention, the whole grains may include at least three or five selected from brown rice, wheat, barley, oat, Sorghum, black rice, red rice, green rice, buckwheat, corn, kamut, quinoa and chick peas, but it is not limited thereto.

The sprouting step (a) may include:

washing the whole grains, immersing the same in cold water at 10 to 15° C. for 10 to 14 hours, followed by dehydrating the same;

spraying warm water at 28 to 30° C. over the immersed and dehydrated whole grains four times for 16 hours at an interval of 4 hours;

after spraying the warm water as described above, washing the whole grains with water at 20 to 22° C. twice for 8 hours at an interval of 4 hours; and

after washing with water as described above, immersing the whole grains in water at 20 to 22° C. for 4 hours, followed by washing the same with cold water at 10 to 15° C. and then drying at 34 to 36° C. for 16 hours.

Further, the step (a) may germinate sprouts of the whole grains to reach 0.1 to 5 mm, preferably, 1 to 3 mm, thereby maximizing contents of dietary fiber and GABA.

The processing of whole grains in step (b) may include, specifically: (i) steaming the sprouted whole grains; (ii) primary drying; (iii) milling; (iv) baking; and (v) secondary drying the whole grains.

The steaming in step (i) may include adding distilled water or water to the sprouted whole grains, applying a pressure of 1.35±1 kgf/cm and feeding steam for 60±5 minutes so as to maintain a water content of the whole grains to 31±1% while steaming the same.

The whole grains to be steamed are not limited, but preferably, include 20 to 80% by weight (‘wt. %’) of sprouted brown rice, 10 to 60 wt. % of sprouted barley, 10 to 60 wt. % of sprouted wheat, 1 to 30 wt. % of sprouted oat, and 1 to 30 wt. % of sprouted Sorghum.

Further, the method may further include, after steaming in step (i), mildly steaming the whole grains with a water content of 31±1% for 10 to 15 minutes to attain water balance of the steamed whole grains.

The primary drying in step (ii) is a step of drying the steamed whole grains at room temperature for 30 to 40 minutes to reach a water content of 29±2%. If the water content is beyond the above range, formation may not be well done in the subsquent milling process.

The milling in step (iii) is a step of milling the primary dried whole grains after the primary drying to have a thickness of 0.1 to 0.7 mm, wherein the thickness may be within the above range depending on irregularity in surface of the whole grains.

The baking in step (iv) is a step of baking the milled whole grains in a heat source at 280±20° C. for 30±5 seconds to have a water content of 4±1%. The whole grains after the baking process may have a specific gravity of 100 to 500 g/L, preferably 150 to 350 g/L, but it is not limited thereto.

The secondary drying in step (v) is a step of secondly drying the whole grains after the baking (iv) in a dryer at 100±20° C. to reach a water content of 2±1%, and may be implemented to prevent a decrease in contents of dietary fiber and GABA while improving grain texture.

The whole grains prepared after the step (v) may further be subjected to packaging (vi), thereby being completed.

The whole grains prepared by the method for processing geminated whole grain mixture according to the present invention may have a hardness reduced by 3 to 15 times or more than the same before processing, so as to have soft texture while not being dried and hardened even after storage. Further, a loss of nutrients such as dietary fiber and GABA may be minimized, thereby being beneficial to health.

### Advantageous Effects

As described above, the present invention may provide whole grains with soft texture and a method for producing the same, which includes: sprouting and processing whole grains that have different shapes and physical properties, as well as rough texture not easy to intake, so as to maintain gelatinization of starch (in α state), thereby obtaining soft texture. Further, the method for mixing and processing whole grains according to the present invention may prevent loss of dietary fiber and GABA contained in the whole grains and use no sugar or additives, thereby being helpful in preventing adult diseases and promoting health.

### BRIEF DESCRIPTION OF DRAWINGS

FIGS. 1 to 5 show grain structures of sprouted brown rice, barley, oat and Sorghum before and after processing, respectively (photographs showing a difference in thickness of the surface of whole grains; photographed by three-spot microscope with an eye lens 10× and an object glass 40×), in particular,

FIG. 1 is photographs showing sprouted brown rice before and after processing, wherein the brown rice before processing (left) and after processing (middle) and the grain structure (right) after processing are illustrated;

FIG. 2 is photographs showing sprouted wheat before and after processing, wherein the wheat before processing (left) and after processing (middle) and the grain structure (right) after processing are illustrated;

FIG. 3 is photographs showing sprouted barley before and after processing, wherein the barley before processing (left) and after processing (middle) and the grain structure (right) after processing are illustrated;

FIG. 4 is photographs showing sprouted oat before and after processing, wherein the oat before processing (left) and after processing (middle) and the grain structure (right) after processing are illustrated;

FIG. 5 is photographs showing sprouted Sorghum before and after processing, wherein the Sorghum before processing (left) and after processing (middle) and the grain structure (right) after processing are illustrated;

FIG. 6a illustrates results of iodine reaction examination of the whole grains before processing;

FIG. 6b illustrates results of iodine reaction examination of the whole grains after processing, wherein changing color into blue indicates gelatinization of starch (in α state); and

FIG. 7 illustrates results of sensory examination of the sprouted whole grains according to the present invention.

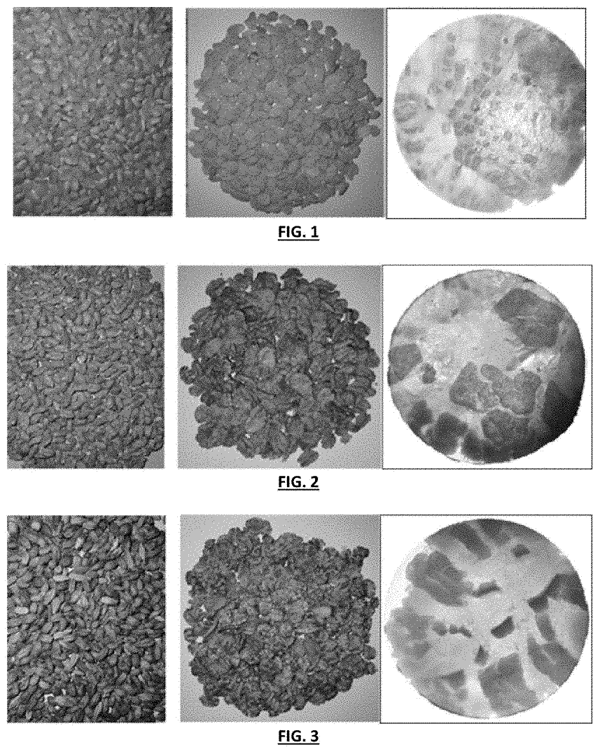

### MODE FOR CARRYING OUT INVENTION

Hereinafter, the present invention will be described in detail by means of embodiments and experimental examples of the present invention.

However, the following examples and experimental examples are proposed for illustrative purpose, but are not intended to limit subject matters of the present invention.

1. Sprouting of Whole Grains

When grains are sprouted, rough texture of grains may become soft and allow easy intake of the grains, and may maintain dietary fiber components or GABA contained in whole grains without a change even after sprouting.

Sprouting means a phenomenon in which plant seeds sprout or starts growth in proper conditions such as moisture, oxygen, temperature, light, etc., wherein a variety of enzymes begin to act thus to activate breathing and decompose stored nourishment into a state easily used.

Five (5) whole grains including brown rice, wheat, barley, oat and Sorghum were each washed, immersed in cold water at 10 to 15° C. for 10 to 14 hours, followed by dehydration. These five whole grains were each subjected to spraying of worm water at 28 to 30° C. four times for total 16 hours at an interval of 4 hours. Then, the warm water-sprayed five whole grains were each washed with water at room temperature of 20 to 22° C. twice for total 8 hours at an interval of 4 hours. Following this, the washed five whole grains were immersed in water at room temperature of 20 to 22° C. for 4 hours, washed with cold water at 10 to 15° C., followed by drying at 34 to 36° C. for 16 hours. The whole grains were subjected to sprouting, respectively, until germinated sprouts were grown to 1 to 3 mm.

2. Processing of Sprouted Whole Grains

A mixing ratio of five sprouted whole grains (brown rice, barley, wheat, oat and Sorghum) may be obtained by adding each whole grain by the same weight or 10 to 90 wt. % in each step of (i) steaming the sprouted whole grains; (ii) primary drying; (iii) milling; (iv) baking; and (v) secondary drying. According to the present invention, when the intake of whole grains, 30 to 70 wt. % of sprouted brown rice, 10 to 25 wt. % of sprouted barley, 10 to 25 wt. % of sprouted wheat, 1 to 10 wt. % of sprouted oat, and 1 to wt. % of sprouted Sorghum were admixed and used in consideration of favorites, taste, physical properties, etc., and for the convenience in use.

(i) Steaming of Sprouted Whole Grains

The steaming may be performed by mixing the whole grains, adding purified water thereto, applying a pressure of 1.3±1 kgf/cm, feeding steam for 55 to 65 minutes to steam the whole grains, and then, mildly steaming for 10 to minutes, thereby performing gelatinization of starch while maintaining a water content of 31±1%. When the grains are gelatinized to reach α state, amylose or amylopectin components are activated to increase stickiness and viscous properties. As a result, GABA or dietary fiber components in the steamed whole grains may be maintained in the same state as sprouted condition.

(ii) Primary Drying

The crop starch should maintain gelatinization (in α state) to retain physical properties and taste of a final product of whole grains. When the steamed whole grains is dried at a high temperature during primary drying, an outer skin of the whole grains is primary dried to inhibit inner moisture from escaping out of the grains, hence causing case-hardening in which water balance is hardly achieved. In order to prevent this problem, the whole grains are gradually dried at room temperature for 30 to 40 minutes to reach a water content of 29±2%. After primary drying, if the water content is less than 27%, the outer skin may be cracked or finely broken during milling. On the other hand, when the water content is 32% or more, the crops may be sticky or adhered to one another or deposited on a roller, thereby causing a problem in production.

TABLE 1
Appearance of grains during milling to water content after primary drying

| | | 26% to | 27% to | 28% to | 31% to | 32% to | |
|---|---|---|---|---|---|---|---|
| | Less | less | less | less | less | less | |
| Water | than | than | than | than | than | than | 33% or |
| content | 26% | 27% | 28% | 31% | 32% | 33% | more |
| Appearance | Finely | ½ or | Good | Good | Good | Partially | Sticking |
| during | broken | more | | | | sticking | between |
| milling | | broken | | | | between | grains |
| | | | | | | grains | and |
| | | | | | | | deposited |
| | | | | | | | to roller |

From the above results, it could be seen that the water content during milling should be 29±2% in order to prevent the outer skin from cracking or being broken.

(iii) Milling

The gelatinized whole grains should be under milling with a uniform thickness, so as to obtain favorable distribution. If the whole grains spread with the same thickness, the water content may be easily adjusted during baking and secondary drying, and the grains may have better chewing texture in a mouth. Since these five whole grains have different particle sizes and a pressure applied to the whole grains is also different, water content and temperature are important parameters. In order to attain desirable spreading and chewing properties, a water content of 29±2% during milling, room temperature and a thickness of 0.1 to 0.7 mm in consideration of surface irregularity of whole grains may be desirable.

TABLE 2
Phenomenon after baking of whole grains to thickness
and specific gravity during milling

| | Exper- | Exper- | Exper- | Exper- | Exper- |
|---|---|---|---|---|---|
| Section | iment 1 | iment 2 | iment 3 | iment 4 | iment 5 |
| Thickness | Less | 0.1 to | 0.3 to | 0.5 to | More |
| | than 0.1 | 0.3 mm | 0.5 mm | 0.7 mm | than 0.7 |
| | mm | | | | mm |
| Specific | Less | 200 ± 50 | 250 ± 50 | 300 ± 50 | More |
| gravity | than 150 | | | | than 350 |
| (g/L) | | | | | |
| After | Easily | Good | Good | Good | Rigid |
| baking | broken | | | | texture |

From the above results, it could be seen that, when the thickness during milling is less than 0.1 mm and the specific gravity is less than 150 g/L, the grains are easily cracked or tear, whereas the grains are hardly dried and have rigid texture if the thickness is more than 0.7 mm and the specific gravity is more than 350 g/L. Accordingly, the baking is preferably conducted with the thickness of whole grains during milling in a range of 0.1 to 0.7 mm and the specific gravity in a range of 150 to 350 g/L.

(iv) Baking

The baking is a step of uniformly cooking the food using air heated by a heat source. The five whole grains resulting from sprouting, primary drying, steaming and milling should be uniformly cooked in order to desired water content while being hydrated well, thereby providing soft taste and texture in the mouth. The five whole grains obtained after milling should be baked in a heat source at 280±20° C. for 30±5 seconds to reach a water content of 4±1%. At this time, if the water content is less than 3% or the heat source acts to heat for 25 seconds or less, roasted sesame-like savory taste and texture may be deteriorated. Further, if the water content is more than 5% or the heat source acts to heat for more than 35 seconds, the whole grains may be easily broken and have burn smell and taste.

As comparing physical properties of the whole grains relative to the baking temperature of 280±20° C., the specific gravity of 150 to 350 g/L is appropriate. If baking at a lower temperature, moisture inside the whole grains is not sufficiently eliminated thus to exhibit rigid texture. On the other hand, if baking at higher temperature, an outer skin of the whole grains was observed to be burned before the whole grains are swollen. Therefore, after putting the five milled whole grains in the heat source, the grains are preferably baked at a baking temperature of 280±20° C. with a water content of 4±1% and a specific gravity of 150 to 350 g/L for 30±5 seconds.

(v) Secondary Drying

In order to maintain the water content of the five whole grains obtained after sprouting, primary drying, steaming, milling and baking, secondary drying was conducted at 100±20° C. to reach a water content of 2±1%. The secondary drying is a final step of processing the whole grains, wherein water balance is achieved with the water content of 2±1% for 30 minutes.

In order to assess hydration properties of the whole grains produced by the present invention, the whole grains baked at 280±20° C. and secondarily dried at 100±20° C. were introduced in an amount of 1 g into each glass by temperature and shaken 5 times, followed by visually observation. Further, a degree of hydration of the whole grains in water was determined by 5 points scaling (hydration within 1 minute: 4 points, hydration within 3 minutes: 3 points, and hydration within 5 minutes: 2 points). After measuring the degree of hydration of the whole grains, the measured results are shown in Table 3 below.

TABLE 3
Measurement of hydration degree of whole grains to Temperature

| | Section | | | | | |
|---|---|---|---|---|---|---|
| | Present invention | | | Control | | |
| | Temperature | | | | | |
| | 10° C. | 20° C. | 30° C. | 10° C. | 20° C. | 30° C. |
| Degree of | 3.1 | 3.7 | 4.5 | 2.4 | 3.3 | 3.8 |
| hydration | | | | | | |
| Visual | Moder- | Good | Good | Poor | Moder- | Moder- |
| observation | ate | | | | ate | ate |

From the above results, it could be seen that the whole grains of the present invention were softly hydrated within 1 minute while maintaining the original shape at 20° C., thus exhibiting a properly edible state. On the other hand, the control (product of C company) was not easily hydrated at 20° C. and even at 30° C., and showed relatively rigid texture.

With regard to the brown rice and sprouted brown rice in the sprouting step and the processing step, dietary fiber and GABA contents before milling and after baking were measured, and the measured results are shown in Table 4 below.

TABLE 4
Changes in dietary fiber and GABA
to sprouting and processing steps

| | Dietary fiber | GABA |
|---|---|---|
| Processing step | (g/100 g) | (mg/100 g) |
| White rice | 0.72 | 0.71 |
| Brown rice | 1.4 | 1.36 |
| (before sprouting) | | |
| Sprouted brow rice | 2.0 | 10.2 |
| (after sprouting) | | |
| Sprouted brown rice | 3.4 | 9.13 |
| (before milling) | | |
| Sprouted brow rice | 3.2 | 9.08 |
| (after milling) | | |

As described above, it was confirmed that the contents of dietary fiber and GABA increased by sprouting the whole grains are maintained without a change in processed product after milling and baking, otherwise, being increased. In particular, it could be seen that the sprouted brown rice after each of sprouting, milling and baking has higher content of dietary fiber than that of the brown rice whole grains before sprouting, in other words, as the water content is decreased, the content of dietary fiber is relatively increased. That is, although the processing steps of the present invention were implemented, the content of dietary content is not reduced, thereby demonstrating that the present invention has excellent effects. Accordingly, a variety of business expansion in relation to processed whole grain products by processing steps will be proposed.

(vi) Packaging

The whole grains produced as described above were uniformly mixed, followed by packaging the same by 10 g, 40 g, 100 g, 500 g, 1 kg and 10 kg. Small packages of whole grains were again packed in a bigger or large package, followed by storage at room temperature.

### EXAMPLES 1 TO 10

30 to 70 wt. % of brown rice, 10 to 25 wt. % of barley, 10 to 25 wt. % of wheat, 1 to 10 wt. % of oat, and 1 to 10 wt. % of Sorghum were mixed and 300 kg of the prepared whole grains were washed. Then, the washed whole grains were immersed in cold water at 12° C. for 12 hours and dehydrated, followed by spraying warm water over the same for 16 hours. Next, after washing the product with water at room temperature for 8 hours, the product was immersed in water at room temperature and washed with cold water, followed by drying the same at 35° C. for 16 hours to geminate the whole grains, thereby sprouting in a length of 2 to 3 mm. The whole grains were purchased from the Korea Organic Agriculture Association and used. The whole grains may also include black rice, red rice, green rice, buckwheat, corn, kamut, quinoa, chick peas, etc. in addition to the five whole grains described above. Further, the mixing ratio of the whole grains used herein may be selected from a range of 10 to 90 wt. % for each of the whole grain species.

After adding 20 kg of purified water to the sprouted whole grains and steaming the same at a pressure of 1.35±0.05 kgf/cm for 60±5 minutes, mild steaming was conducted for 12.5±0.5 minutes. The steamed whole grains were subjected to primary drying slowly at room temperature for 30±5 minutes to reach a water content of 29±2%. Then, the milled whole grains with a thickness of 0.1 to 0.7 mm were baked at 280±20° C. for 30±5 seconds to have a water content of 4±1%. To reach the water content of 2±1% after sprouting, primary drying, steaming, milling and baking, the whole grains were subjected to secondary drying at 100±20° C. The whole grains after secondary drying were packaged by weight (10 g, 50 g, and 100 g), followed by storage at room temperature.

The following Examples 1 to 5 were implemented with the same mixing ratio but under different processing conditions. In particular, 30 wt. % of sprouted brown rice, 25 wt. % of sprouted barley, 25 wt. % of sprouted wheat, 10 wt. % of sprouted oat and 10 wt. % of sprouted Sorghum were admixed and then subjected to steaming, mild steaming, primary drying, milling, baking and secondary drying in sequential order, followed by briefly assessing sensory functions and physical properties. The assessed results are summarized in Table 5 below.

TABLE 5
Same mixing ratio and different processing conditions (water
content: %, pressure: kgf/cm, time: minute, thickness: mm)

| Section (test | | | | | | | | |
|---|---|---|---|---|---|---|---|---|
| by processing | Example 1 | | | Example 2 | | | Example 3 | |
| conditions) | (wt. %) | | | (wt. %) | | | (wt. %) | |
| Sprouted brown rice | 30 | | | | | | | |
| Sprouted barley | 25 | | | | | | | |
| Sprouted wheat | 25 | | | | | | | |
| Sprouted oat | 10 | | | | | | | |
| Sprouted sorghum | 10 | | | | | | | |
| Total | 100 | | | | | | | |
| | Water | | | Water | | | Water | |
| | content | | Time | content | | Time | content | |
| Section | (%) | Pressure | (minute) | (%) | pressure | (minute) | (%) | Pressure |
| Steaming | 29 | 1.3 | 50 | 30 | 1.35 | 55 | 31 | 1.35 |
| Mild steaming | ″ | ″ | 11 | ″ | ″ | 12 | ″ | ″ |
| Primary drying | 26 | ″ | 20 | 27 | ″ | 25 | 29 | ″ |
| | Water | | | Water | | | Water | |
| | content | Temperature | Thickness | content | Temperature | Thickness | content | Temperature |
| Section | (%) | (° C.) | (mm) | (%) | (° C.) | (mm) | (%) | (° C.) |
| Milling | 26 | Room | 0.1 to 0.7 | 27 | Room | 0.1 to 0.7 | 29 | Room |
| | | temperature | | | temperature | | | temperature |
| | Water | | | Water | | | Water | |
| | content | Temperature | Time | content | Temperature | Time | content | Temperature |
| Section | (%) | (° C.) | (second) | (%) | (° C.) | (second) | (%) | (° C.) |
| Baking | 2 | 280 ± 20 | 30 ± 5 | 3 | 280 ± 20 | 30 ± 5 | 4 | 280 ± 20 |
| Secondary drying | Less than 1 | 100 ± 20 | 30 | 1 | 100 ± 20 | 30 | 2 | 100 ± 20 |

| | | | |
|---|---|---|---|
| Result | Broken during milling and | Good | Good |
| | burned taste after baking | | |

| Section (test | | | | | | | |
|---|---|---|---|---|---|---|---|
| by processing | Example 3 | Example 4 | | | Example 5 | | |
| conditions) | (wt. %) | (wt. %) | | | (wt. %) | | |
| Sprouted brown rice | 30 | | | | | | |
| Sprouted barley | 25 | | | | | | |
| Sprouted wheat | 25 | | | | | | |
| Sprouted oat | 10 | | | | | | |
| Sprouted sorghum | 10 | | | | | | |
| Total | 100 | | | | | | |
| | | Water | | | Water | | |
| | Time | content | | Time | content | | Time |
| Section | (minute) | (%) | Pressure | (minute) | (%) | pressure | (minute) |
| Steaming | 60 | 32 | 1.35 | 65 | 33 | 1.4 | 70 |
| Mild steaming | 12.5 | ″ | ″ | 13 | ″ | ″ | 14 |
| Primary drying | 30 | 31 | ″ | 35 | 32 | ″ | 40 |
| | | Water | | | Water | | |
| | Thickness | content | Temperature | Thickness | content | Temperature | Thickness |
| Section | (mm) | (%) | (° C.) | (mm) | (%) | (° C.) | (mm) |
| Milling | 0.1 to 0.7 | 31 | Room | 0.1 to 0.7 | 32 | Room | 0.1 to 0.7 |
| | | | temperature | | | temperature | |
| | | Water | | | Water | | |
| | Time | content | Temperature | Time | content | Temperature | Time |
| Section | (second) | (%) | (° C.) | (second) | (%) | (° C.) | (second) |
| Baking | 30 ± 5 | 5 | 280 ± 20 | 30 ± 5 | 6 | 280 ± 20 | 30 ± 5 |
| Secondary drying | 30 | 3 | 100 ± 20 | 30 | 4 | 100 ± 20 | 30 |

| | | | |
|---|---|---|---|
| Result | Good | Good | Deposited on roller during |
| | | | milling and rigid texture |

In the case of Example 1, the grains were broken during milling and had burned flavor and taste after baking. Further, in the case of Example 5, the grains were deposited on the roller during milling and had rigid texture. The above results, in particular, the experiments by processing conditions demonstrated that the whole grains processed in Example 2, Example 3 and Example 4 had best texture. That is, under the conditions of water content of 31±1% during steaming, a pressure of 1.35 kgf/cm and mild steaming for 12.5±0.5 minutes, the primary drying was conducted at room temperature to reach a water content of 29±2%, the milling was conducted to obtain a thickness of 0.1 to 0.7 mm, the baking was conducted at 280±20° C. for 30±5 seconds to reach a water content of 4±1%, and the secondary drying was conducted at 100±20° C. for 30 minutes to reach a water content of 2±1%.

As such, after obtaining optimum processing condition data in regard to water content, pressure and time, experiments such as Examples 6 to 10 were performed to confirm mixing and processing conditions by mixing ratios. Results of the experiments are summarized in Table 6.

TABLE 6
Mixing and processing conditions by mixing ratio (water content:
%, pressure: kgf/cm, time: minute, thickness: mm)

| Section (test | | | | | | | | |
|---|---|---|---|---|---|---|---|---|
| by ratio of | Example 6 | | | Example 7 | | | Example 8 | |
| raw material) | (wt. %) | | | (wt. %) | | | (wt. %) | |
| Sprouted brown rice | 40 | | | 50 | | | 56 | |
| Sprouted barley | 25 | | | 20 | | | 18 | |
| Sprouted wheat | 25 | | | 20 | | | 18 | |
| Sprouted oat | 6 | | | 5 | | | 4 | |
| Sprouted sorghum | 4 | | | 5 | | | 4 | |
| Total | 100 | | | 100 | | | 100 | |
| | Water | | | Water | | | Water | |
| | content | | Time | content | | Time | content | |
| Section | (%) | Pressure | (minute) | (%) | Pressure | (minute) | (%) | Pressure |
| Steaming | 31 ± 1 | 1.35 | 60 ± 5 | 31 ± 1 | 1.35 | 60 ± 5 | 31 ± 1 | 1.35 |
| Mild steaming | ″ | ″ | 12.5 ± 0.5 | ″ | ″ | 12.5 ± 0.5 | ″ | ″ |
| Primary drying | 29 ± 2 | ″ | 30 ± 5 | 29 ± 2 | ″ | 30 ± 5 | 29 ± 2 | ″ |
| | Water | | | Water | | | Water | |
| | content | Temperature | Thickness | content | Temperature | Thickness | content | Temperature |
| Section | (%) | (° C.) | (mm) | (%) | (° C.) | (mm) | (%) | (° C.) |
| Milling | 29 ± 2 | Room | 0.1 to 0.7 | 29 ± 2 | Room | 0.1 to 0.7 | 29 ± 2 | Room |
| | | temperature | | | temperature | | | temperature |
| | Water | | | Water | | | Water | |
| | content | Temperature | Time | content | Temperature | Time | content | Temperature |
| Section | (%) | (° C.) | (second) | (%) | (° C.) | (second) | (%) | (° C.) |
| Baking | 4 ± 1 | 280 ± 20 | 30 ± 5 | 4 ± 1 | 280 ± 20 | 30 ± 5 | 4 ± 1 | 280 ± 20 |
| Secondary drying | 2 ± 1 | 100 ± 20 | 30 | 2 ± 1 | 100 ± 20 | 30 | 2 ± 1 | 100 ± 20 |

| | | | |
|---|---|---|---|
| Result | Strong barley flavor | A little strong flavor | Overall balanced |
| | | of wheat and oat | flavor |

| Section (test | | | | | | | |
|---|---|---|---|---|---|---|---|
| by ratio of | Example 8 | Example 9 | | | Example 10 | | |
| raw material) | (wt. %) | (wt. %) | | | (wt. %) | | |
| Sprouted brown rice | 56 | 60 | | | 70 | | |
| Sprouted barley | 18 | 15 | | | 10 | | |
| Sprouted wheat | 18 | 15 | | | 10 | | |
| Sprouted oat | 4 | 3 | | | 2 | | |
| Sprouted sorghum | 4 | 7 | | | 8 | | |
| Total | 100 | 100 | | | 100 | | |
| | | Water | | | Water | | |
| | Time | content | | Time | content | | Time |
| Section | (minute) | (%) | pressure | (minute) | (%) | pressure | (minute) |
| Steaming | 60 ± 5 | 31 ± 1 | 1.35 | 60 ± 5 | 31 ± 1 | 1.35 | 60 ± 5 |
| Mild steaming | 12.5 ± 0.5 | ″ | ″ | 12.5 ± 0.5 | ″ | ″ | 12.5 ± 0.5 |
| Primary drying | 30 ± 5 | 29 ± 2 | ″ | 30 ± 5 | 29 ± 2 | ″ | 30 ± 5 |
| | | Water | | | Water | | |
| | Thickness | content | Temperature | Thickness | content | Temperature | Thickness |
| Section | (mm) | (%) | (° C.) | (mm) | (%) | (° C.) | (mm) |
| Milling | 0.1 to 0.7 | 29 ± 2 | Room | 0.1 to 0.7 | 29 ± 2 | Room | 0.1 to 0.7 |
| | | | temperature | | | temperature | |
| | | Water | | | Water | | |
| | Time | content | Temperature | Time | content | Temperature | Time |
| Section | (second) | (%) | (° C.) | (second) | (%) | (° C.) | (second) |
| Baking | 30 ± 5 | 4 ± 1 | 280 ± 20 | 30 ± 5 | 4 ± 1 | 280 ± 20 | 30 ± 5 |
| Secondary drying | 30 | 2 ± 1 | 100 ± 20 | 30 | 2 ± 1 | 100 ± 20 | 30 |

| | | | |
|---|---|---|---|
| Result | Overall balanced | A little strong brown | Strong brown |
| | flavor | rice flavor | rice flavor |

As a result of the experiments with the mixing ratios of whole grains as listed above, it could be seen that, when processing with the mixing ratio in Example 8, both of overall flavor and texture are favorable. That is, under the conditions of water content of 31±1% during steaming and pressure of 1.35 kgf/cm and mild steaming of 12.5±0.5 minutes, the primary drying was conducted at room temperature to reach a water content of 29±2%, the milling was conducted to obtain a thickness of 0.1 to 0.7 mm, the baking was conducted at 280±20° C. for 30±5 seconds to reach a water content of 4±1%, and the secondary drying was conducted at 100±20° C. for 30 minutes to reach a water content of 2±1%. It was found that Example 6 has strong barley flavor, Example 7 has a little strong flavor of wheat and oat, Example 9 has a little strong brown rice flavor, and Example 10 has strong brown rice flavor.

With regard to the processed whole grains with the mixing ratios (Examples 1 to 10), physical properties (hardness) were measured. In order to determine preference to Examples 7, 8 and 9, sensory examination was performed.

### EXPERIMENTAL EXAMPLE 1

### Measurement of Physical Properties (Hardness)

Physical properties were measured by a physical property measurement device (a hardness tester, CR-3000EX) (wherein a pressure was applied to a sample using a cylindrical measurement device having a diameter of 4 mm, followed by measuring applied force when the sample was suppressed by 1.5 mm, while a table moving speed was determined to be 60 mm/min). Measured results are shown in Table 7.

TABLE 7
Results of physical property (hardness) measurement

| | Measured hardness (gf/cm²) | | | |
|---|---|---|---|---|
| | | After | After | After |
| | Before | processing | processing | processing |
| Type | processing | (Experiment 1) | (Experiment 2) | (Experiment 3) |
| Sprouted | 366,880 | 53,650 | 53,360 | 54,014 |
| brown rice | | | | |
| Sprouted | 466,190 | 31,864 | 31,694 | 30,995 |
| barley | | | | |
| Sprouted | 398,530 | 38,213 | 39,131 | 37,896 |
| wheat | | | | |
| Sprouted | 171,520 | 63,329 | 64,269 | 62,974 |
| oat | | | | |
| Sprouted | 225,760 | 23,615 | 25,542 | 24,016 |
| corn | | | | |

From the above results, the physical properties measured by the present invention, in particular, the hardness value after processing was: about 7 times for sprouted brown rice; about 15 times for sprouted barley; about 10 times for sprouted wheat; about 3 times for sprouted oat; and about 10 times for sprouted Sorghum, respectively, lower than the hardness before processing. Therefore, it could be seen that the hardness after processing is generally lowered than that before processing, thereby providing soft texture.

According to the measured results of physical properties of the sprouted whole grains, the hardness was in a range of about 20,000 to 65,000 gf/cm², which is less than 65 kgf/cm², and a difference in physical properties after processing between the five whole grains was not significant. Therefore, it could be understood that these whole grains have substantially uniform physical properties.

### EXPERIMENTAL EXAMPLE 2

### Determination of Iodation

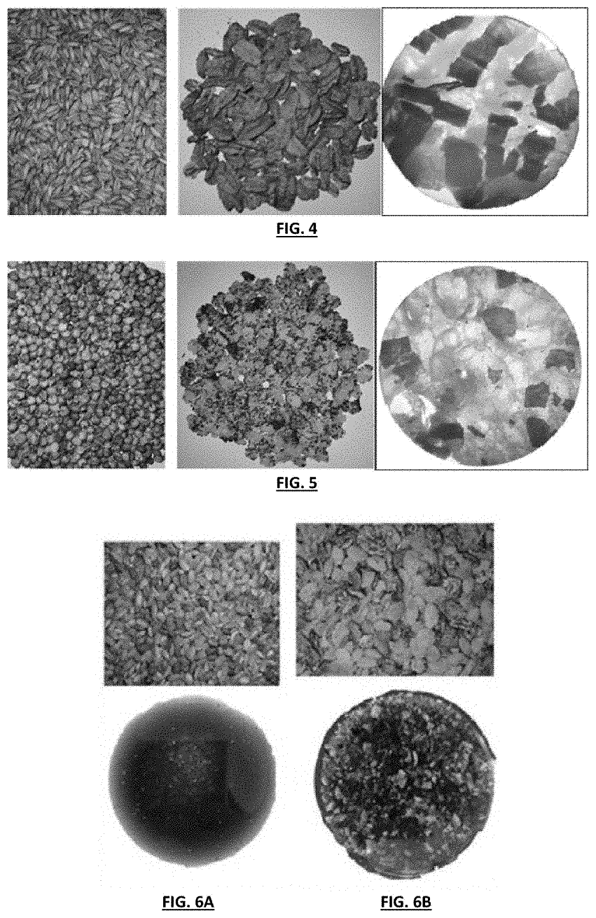

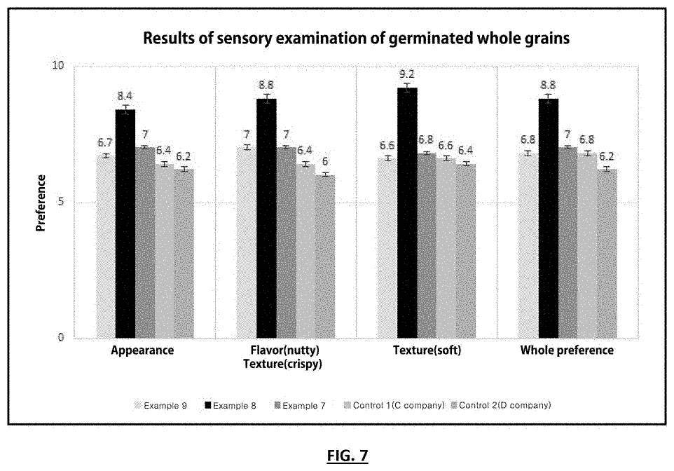

After putting 10 g of sample in 100 ml of distilled water and stirring well, an iodine solution was added in drops until a color of the sample was changed. As shown in FIG. 6(a), violet means starch in β state (aging). Further, as shown in FIG. 6(b), blue indicates gelatinization (in α state) of starch. The five sprouted whole grains appeared blue in iodine reaction, demonstrating that the whole grain processed product of the present invention is in a state of gelatinization.

### EXPERIMENTAL EXAMPLE 3

### Sensory Examination

Well trained panel members (each man and woman in 20s, 30s, 40s and 50s, respectively) have evaluated appearance, flavor (nutty taste), texture (soft) and whole preference on the basis of 10-point scale (9 or more: excellent, 8 or more: good, 6 or more: normal). Results of the evaluation are shown in Table 8 below.

TABLE 8
Results of sensory examination

| | Example | Example | Example | Control | Control |
|---|---|---|---|---|---|
| Section | 9 | 8 | 7 | 1 | 2 |
| Appearance | 6.7 | 8.4 | 7 | 6.4 | 6.2 |
| Flavor | 7 | 8.8 | 7 | 6.4 | 6 |
| (nutty) | | | | | |
| Texture | | | | | |
| (crispy) | | | | | |
| Texture | 6.6 | 9.2 | 6.8 | 6.6 | 6.4 |
| (soft) | | | | | |
| Whole | 6.8 | 8.8 | 7 | 6.8 | 6.2 |
| preference | | | | | |

From the above results, it was confirmed that sensory examination results are excellent in the order of Example 8, Example 7, Example 9, Control 1 (C company), and Control 2 (D company), in particular, Example 8 showed the highest whole preference. Further, a difference in whole preference between Example 7, Example 8 and Example 9 is considered to be a difference in preference depending upon processing conditions.

### INDUSTRIAL APPLICABILITY

The whole grains of the present invention are sugar-free and additive-free, which are produced by mixing separate and sprouted whole grains at a time and processing the same so as to maintain gelatinization of starch (in α state) and provide soft texture. Further, since there is no loss of physiologically active components such as dietary fiber and GABA, the whole grains of the present invention are helpful in preventing adult diseases and promoting health, thereby achieving industrial applicability.

1. A method for processing sprouted whole grain mixture, comprising:
(a) sprouting whole grains; and
(b) processing the sprouted whole grains.

2. The method according to claim 1, wherein the whole grains are five or more selected from brown rice, wheat, barley, oat, Sorghum, black rice, red rice, green rice, buckwheat, corn, kamut, quinoa and chick peas.

3. The method according to claim 1, wherein the sprouting step (a) comprises:
washing the whole grains, immersing the same in cold water at 10 to 15° C. for 10 to 14 hours, followed by dehydrating the same;
spraying warm water at 28 to 30° C. over the immersed and dehydrated whole grains four times for 16 hours at an interval of 4 hours;
after spraying the warm water as described above, washing the whole grains with water at 20 to 22° C. twice for 8 hours at an interval of 4 hours; and
after washing with water as described above, immersing the whole grains in water at 20 to 22° C. for 4 hours, followed by washing the same with cold water at 10 to 15° C. and then drying at 34 to 36° C. for 16 hours.

4. The method according to claim 1, wherein the step (a) is characterized by germinating sprouts of the whole grains to reach a length of 1 to 3 mm.

5. The method according to claim 1, wherein the processing of whole grains in step (b) comprises:
(i) steaming the sprouted whole grains;(ii) primary drying; (iii) milling; (iv) baking; and (v) secondary drying of the whole grains.

6. The method according to 5, wherein the steaming in step (i) comprises adding distilled water or water to the sprouted whole grains, applying a pressure of 1.35±1 kgf/cm and feeding steam for 60±5 minutes so as to maintain a water content of the whole grains to 31±1% while steaming the same.

7. The method according to claim 5, wherein the whole grains to be steamed in step (i) comprise 20 to 80 wt. % of sprouted brown rice, 10 to 60 wt. % of sprouted barley, 10 to 60 wt. % of wheat, 1 to 30 wt. % of sprouted oat, and 1 to 30 wt. % of sprouted Sorghum.

8. The method according to claim 5, further comprising, after steaming in step (i), mildly steaming the whole grains with a water content of 31±1% for 10 to 15 minutes to attain water balance of the steamed whole grains.

9. The method according to claim 5, wherein the primary drying in step (ii) is a step of firstly drying the steamed whole grains at room temperature for 30 to 40 minutes to reach a water content of 29±2%.

10. The method according to claim 5, wherein the milling in step (iii) is a step of milling the primary dried whole grains after the primary drying to have a thickness of 0.1 to 0.7 mm.

11. The method according to claim 5, wherein the baking in step (iv) is a step of baking the milled whole grains in a heat source at 280±20° C. for 30±5 seconds to have a water content of 4±1%.

12. The method according to claim 5, wherein the whole grains after the baking process (iv) have a specific gravity of 150 to 350 g/L.

13. The method according to claim 5, wherein the secondary drying in step (v) is a step of drying the whole grains after the baking (iv) in a dryer at 100±20° C. to reach a water content of 2±1%.

14. The method according to claim 1, wherein a hardness of whole grains is reduced by 3 to 15 times or more of the hardness before processing.

15. Whole grains processed by the method according to claim 1.

16. The whole grains according to claim 15, wherein the whole grains comprise 20 to 80 wt. % of sprouted brown rice, 10 to 60 wt. % of sprouted barley, 10 to 60 wt. % of sprouted wheat, 1 to 30 wt. % of sprouted oat, and 1 to 30 wt. % of sprouted Sorghum.
